(19) United States
(12) Patent Application Publication
(10) Pub. No.: US 2003/0011261 A1
(43) Pub. Date: Jan. 16, 2003

(54) Electromagnetic, "fuelless," passenger vehicle (automobile)

(76) Inventor: Chester White, Corona, NY (US)

Correspondence Address: Chester White, 110-64 Queens Blvd. # 243, Forest Hills, NY, 11375, US

(21) Appl. No.: 10/079,471

(22) Filed: Feb. 19, 2002

Related U.S. Application Data
(60) Provisional application No. 60/269,164, filed on Feb. 20, 2001.

(51) Int. Cl. H02K 21/00

(52) U.S. Cl. 310/152

(57) ABSTRACT

This invention would be the first passenger automobile not requiring gas or any other fuel of any kind; nor will it require either solar or electric energy. The vehicle will operate, (will be powered) by the dynamics of the physical effects of electro-magnetism, centrifugal/centripital forces arising from the momentum of two independently spinning metalic discs, facing each other horizontally, and moving in alternate, (clockwise and counterclockwise) directions. These “Drive Discs” are magnetized at their perpendicular edges. Between these two discs are two rotating Drive Shafts which connect to front and rear wheel gear hubs. Sustained “spin” of discs, (torque of drive shafts) is achieved by the natural repulsive forces of two magnets having the same polarity. All variations in speed, etc. are computer controlled for the essential power train torque rotation and locomotion of the vehicle.

This novel idea drastically alters the perception of the automobile with its internal combustion engine, need for a radiator, muffler, anti-freeze, etc. In fact, this vehicle does not have what is usually thought of as an “engine.” That is, it operates under the dynamics of physical laws and applied electromagnetic force for mechanical propulsion and horsepower. Above all, the novel idea addresses both air pollution, global oil depletion concerns, and protracted monetary expense.

### BACKGROUND—FIELD OF INVENTION

This invention relates to a passenger automobile which does not require liquid or combustible fuel of any kind for operation.

### BACKGROUND—DESCRIPTION OF PRIOR ART

It is known that many attempts have been made to invent an automobile which utilizes the least amount of liquid fuel for operation of the vehicle. Success of the creation of any such vehicle would require unmitigated performance and mileage objectives. The present invention does not use fossil fuel. On the contrary, it operates on principles of physics involving electromagnetism. Together with the physical dynamics of centrifuge, momentum, and torque, the idea for this passenger vehicle supersedes all others in that it addresses vital environmental situations which are regularly emphasized in regards to automobile emissions, in addition to the ongoing dependence on foreign oil production and concerns for its eventual global depletion. There appears not to exist an automobile of record which addresses the dillemma forestated as does the present invention of an electromagnetic motor vehicle.

As concerns the component electromagnetic system structured into present invention, Dukowicz et al., U.S. Pat. No. 3,815,511, Jun. 11, 1974, introduces a magnetic propulsion and levitation system for high speed vehicles to travel over an established readbed. Through sequentially-energized coils operating with superconducting magnets, the vehicle is propelled for locomtion. It is akin to the “Mag-Lev” technology extant in several foreign countries. Though this system is well for high-speed, high-occupancy transportation, it does not address the, essentially, more inexpensive undertaking for expediting a truly, more personal (individualized) transportation implementation introduced by the present invention. Such technology and relevant infrastructure required to effectuate the Dukowicz et al. system would require an immense effort in regards to lobbying governments for huge financial considerations.

Both the Dukowicz et al. system and that of Johnson, U.S. Pat. No. 5,402,021, Mar. 28, 1995, utilize both electromagnetic and permanent magnet systems for the propulson of a vehicle. The vehicles designed to carry larger numbers of passengers than the accommodations presumed for the present invention: one to six persons as in the typical passenger automobile.

The Rotary Magnet Device introduced by D. J. Cunningham, U.S. Pat. No. 4,443,776, Apr. 17, 1984, discloses “at least two circular arrays of wedge-shaped magnetized elements” which can create a magnetic field bringing about a rotary motion once the magnetic field of the respective arrays are brought together to interact. However, this system does not approximate the novel element of two spinning discs, horizontally-stacked whose opposite, magnetized spin, (clockwise & counterclockwise) would cause an interfacing “drive shaft” gear head to rotate, making conventionally connected diferential gears to effectively turn under the control of the operator.

The only prior art remotely similar to the present invention is that of the Magnetic Propulsion System introduced by Thomas J. Clapham, U.S. Pat. No. 3,927,620, Dec. 23, 1975. Nevertheless, the Clapham system, though utilizing electromagnetic dynamics and levitation elements for the propulsion, the overall institution of such system would, as forestated in regards to the above-mentioned propulsion vehicles are, first of all, not for unproblematic ease of implementation in society. Cost factors for investment and huge technological factors are involved. The relevant comparison between the Clapham system and the present invention entails the factor of singular operator for personal utilization by persons desiring at any one given time to “go for a drive” to wherever one wants. Nevertheless, the necessities for implementation for one over the other constitutes the rationale for priority for the present invention, The Electromagnetic, “fuelless,” passenger vehicle.

### OBJECTS AND ADVANTAGES

More important than the obvious deleterious factors involved with cost and negative environmental concerns involved with implementation of all other innovations proposed above, the present passenger vehicle proposes other, “quality-of-life,” (and health) issues. These are:

a. to provide a passenger vehicle which will address the ongoing concerns that society, at large, has for the quality of the air. Cars which do not spew any automobile exhaust emissions into the air will constitute an immense factor in the preservation of health, particularly those affected with adverse or compromised respiratory conditions.

b. to provide a passenger vehicle which will use no gasoline or any other fossil fuel. Such elimination of liquid fuel usage constitutes an reshaping of, even, political relations among oil-producing countries and the United States.

c. to provide a passenger vehicle which will allow the consumer to save an immense amount of money now being spent on gasoline.

d. to provide a passenger vehicle which will allow a more trouble-free automobile which will not have the usual motor and engine breakdown and repair required by the contemporary automobile. There will not be the friction and heat buildup as is common with the internal combustion engine.

e. to provide a passenger vehicle which will provide smooth, trouble-free, operation.

### SUMMARY

The present invention will operate, (will be powered) by the dynamics of the physical laws of electromagnetism. Centifugal and momentum forces arising from the clockwise and counterclockwise spin of two metallic dics whose peripheral rims are magnetized with the same polarity as four facing stationary electromagnets thus making the rims, (Drive Discs) to spin, causing the movement of the vehicle.

### DRAWINGS

Page 1

Shows the conventional passenger automobile featuring, on the underside, (under-carriage) the Drive-Disc Housing in which is the component system shown on page 2.

Page 2 FIG. 1 shows Rotation using Propulsion.

FIG. 2 Distribution of power to gear, (3) from disc, (2)

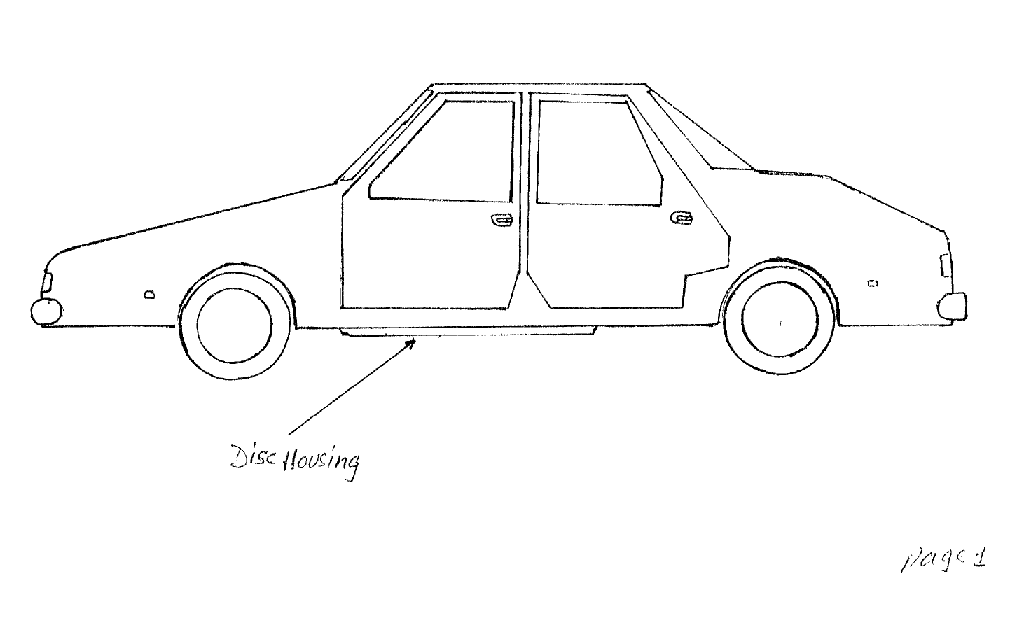

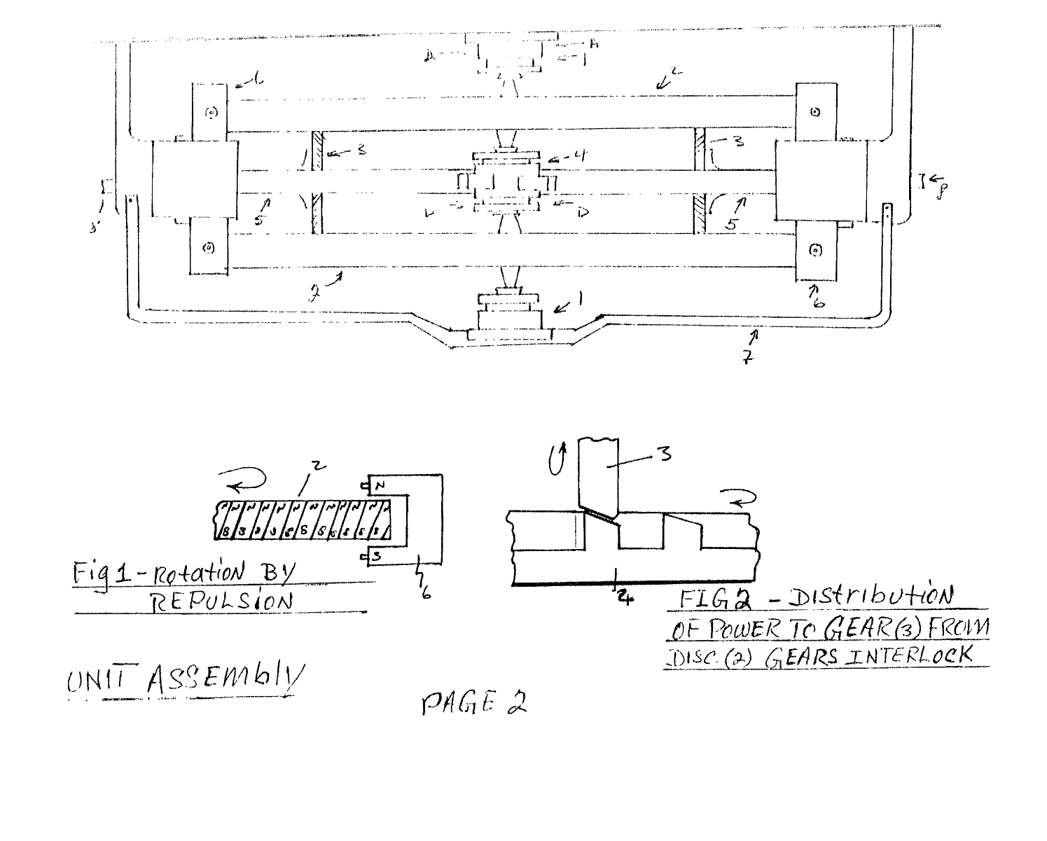

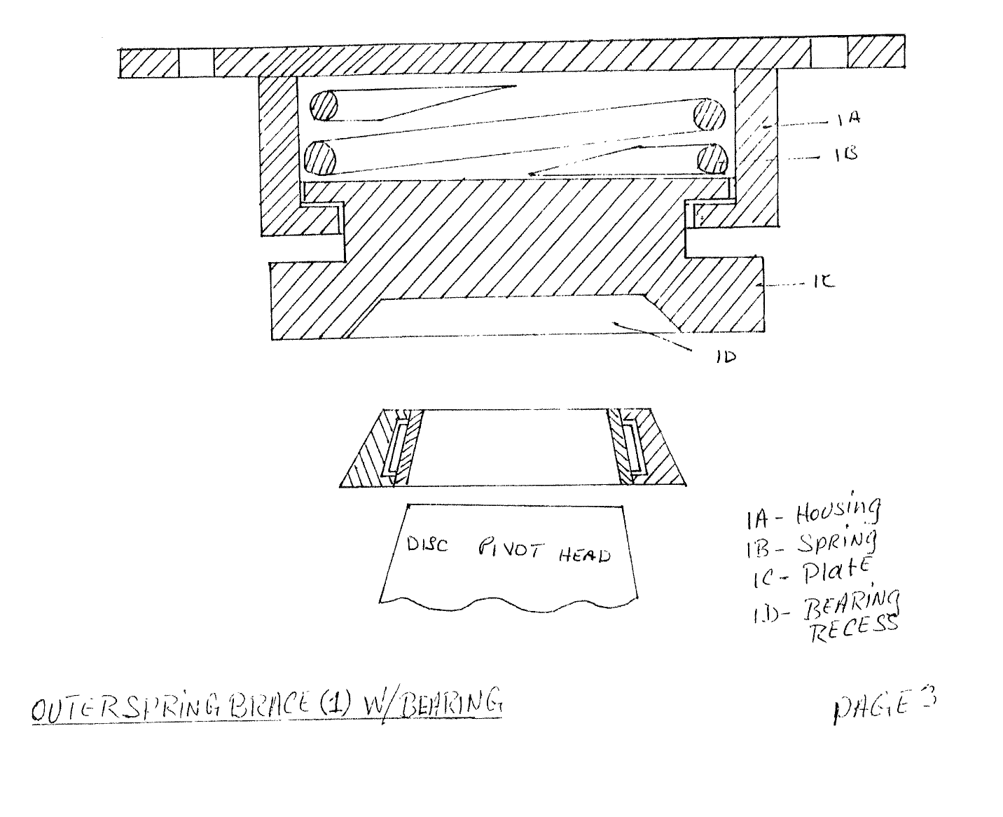

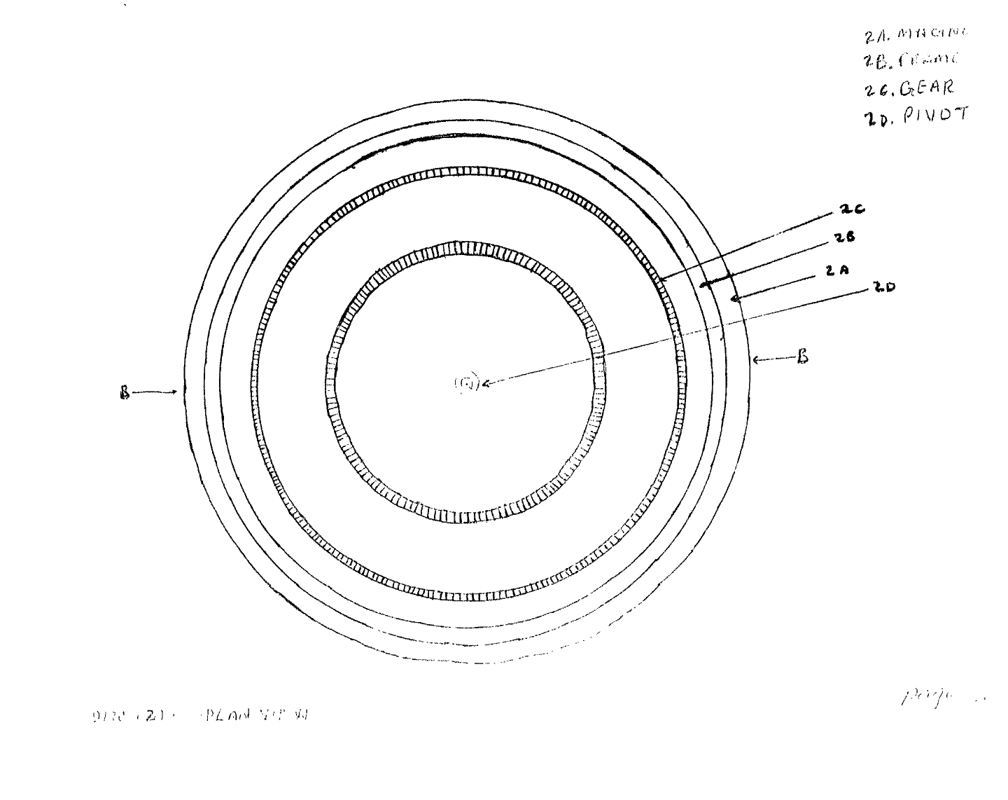

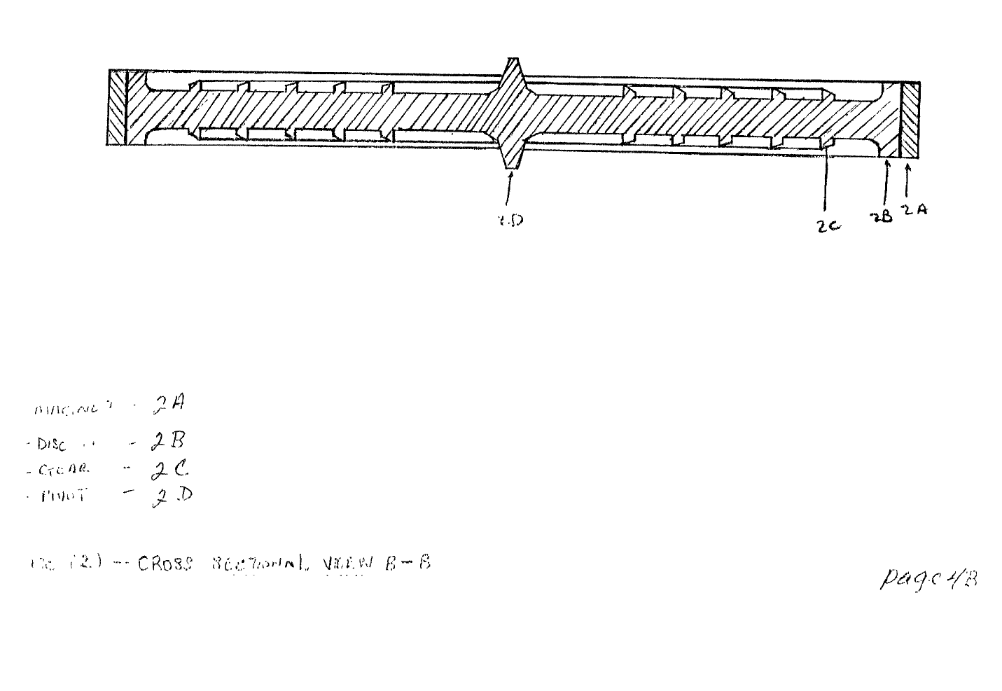

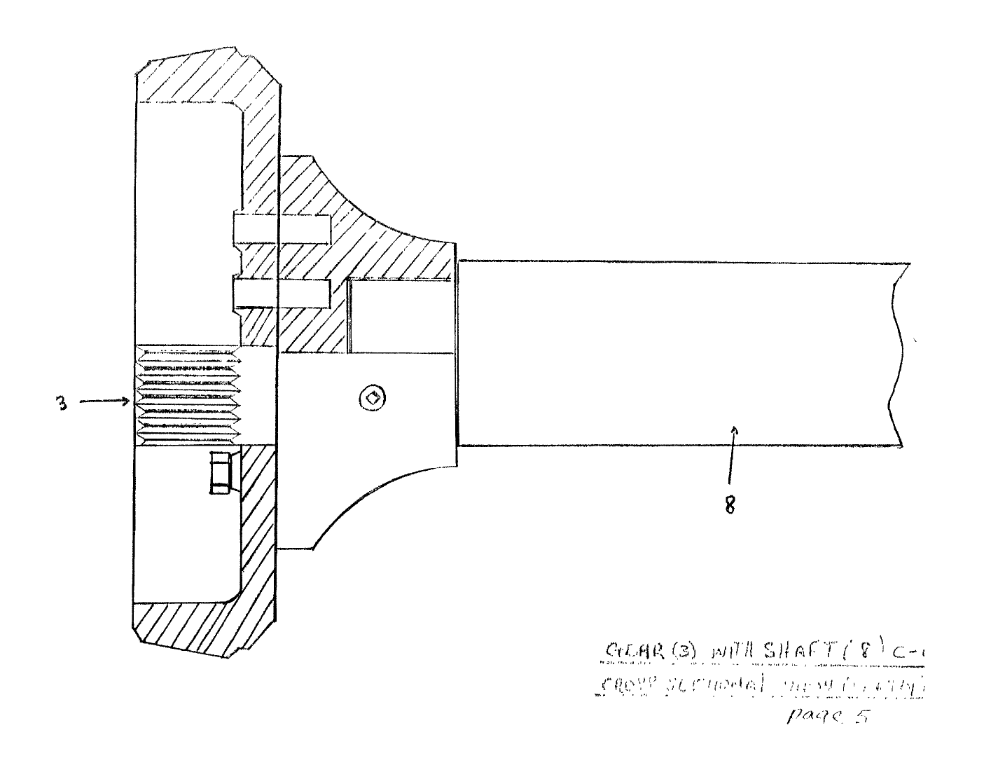

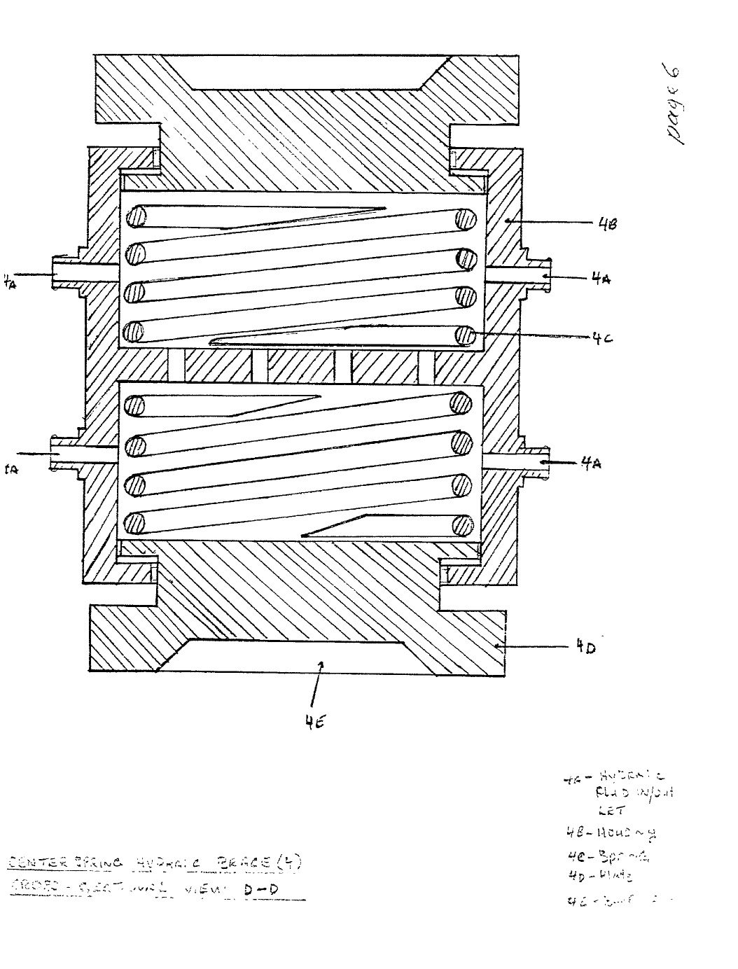

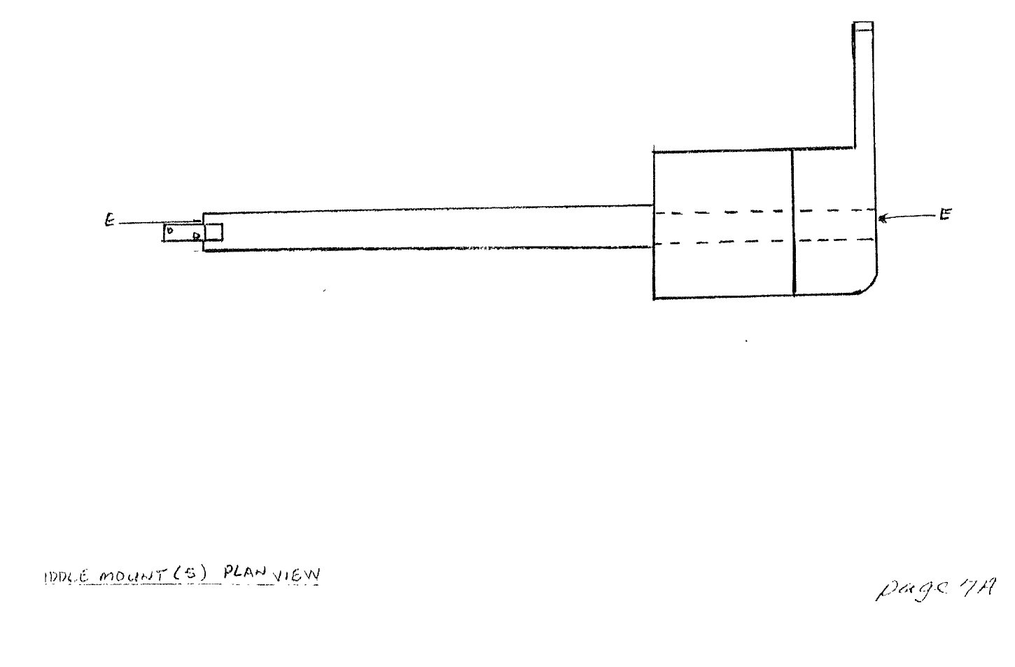

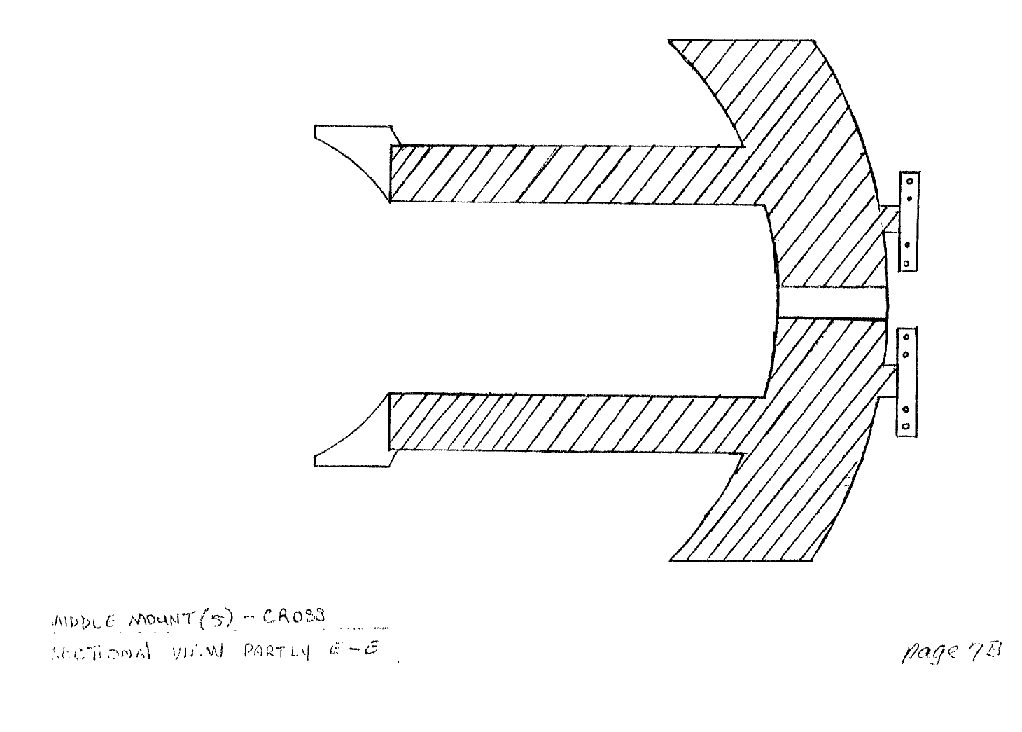

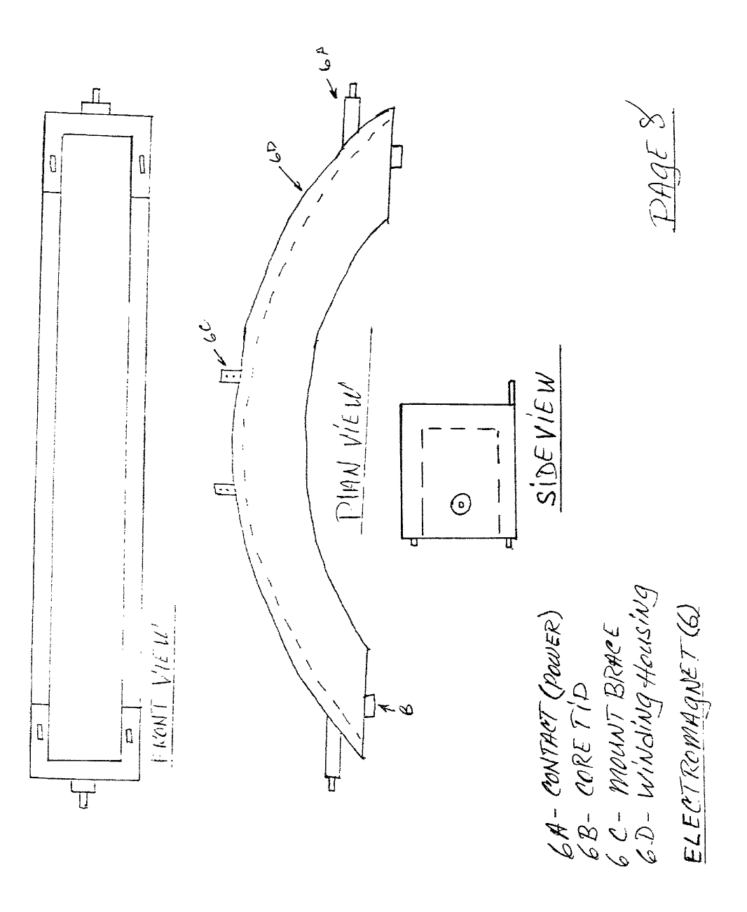

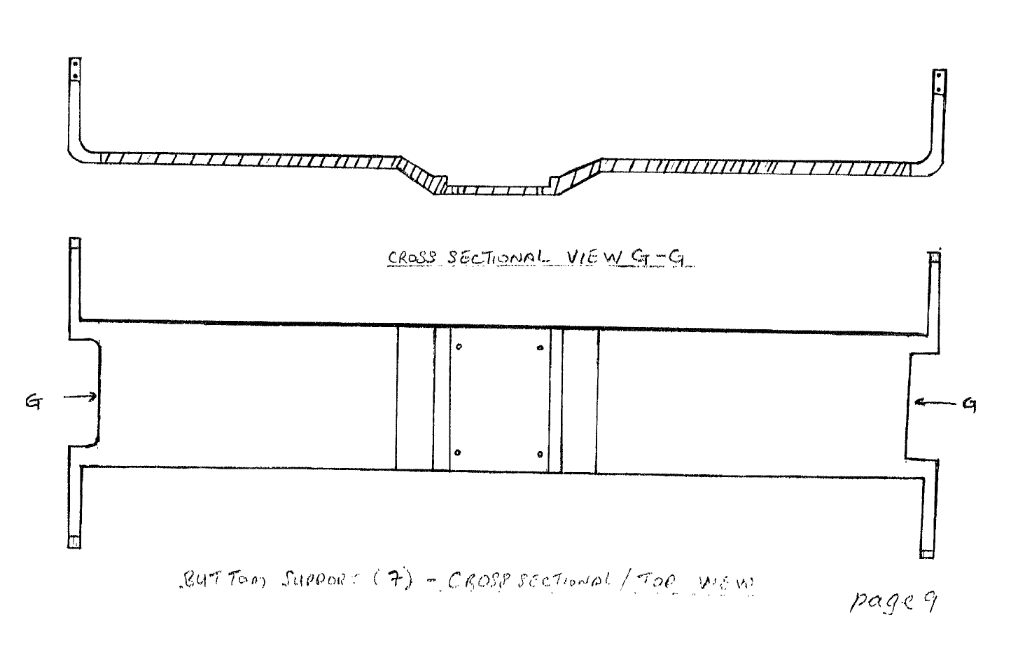

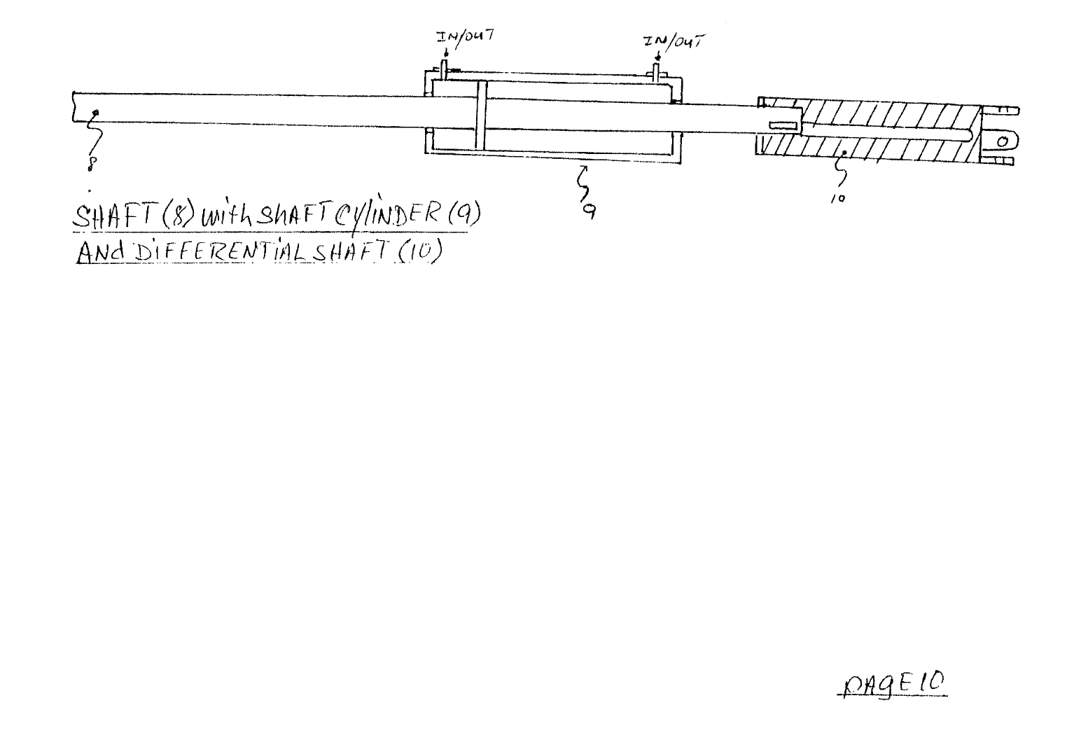

Page 3 FIG. 1 Outer Spring Brace with Bearing and cross-sectional View

Page 4A Drive Disc—in plain view

Page 4B Drive Disc—in cross-sectional view

Page 5 Gear, (3) and shaft, (8) with partial cross-sectional view

Page 6 Center Spring Hydraulic Brace, (4) cross-sectional view

Page 7A Middle Mount, (5) plain view

Page 7B Middle Mount, (5) in partial cross-sectional view

Page 8 Electromagnet, (6) showing front and side views

Page 9 Bottom Support, (7) and cross-sectional, top view

Page 10 Drive Shaft, (8) with shift cylinder, (9) and Differential Shaft, (10)

Reference Numbers In Drawings

| | |
|---|---|
| 1 Top and Bottom Braces | 2 Drive Discs |
| 3 Gears | 4 Center Spring Hydraulic Brace |
| 5 Middle Mount | 6 Electromagnets |
| 7 Bottom Support | 8 Drive Shaft |
| 9 Shift Cylinder | 10 Variable-Position Drive Shaft |

### DETAILED DESCRIPTION, (OPERATION—PREFERRED EMBODIMENT)

A preferred embodiment of present invention for reference 1 on page two identify Top/Bottom Spring Braces. These keep the Drive Discs 2 firmly in position and enable said Drive Discs to move up and down when changing the gear position to vary the speed with the aid of the Center Spring Hydraulic Brace 4 (pg. 6). Drive Discs 2 rotate when the electromagnet 6 is activated, (note p. 2). Gears 3, (note p. 5) revolve as the Drive Discs 2 rotate once they are in the “Drive Position,” (interlocking with gears on the facing Drive Discs 2). They distribute the drive power to the Drive Shaft 8 (pg. 2). The work of the Center Spring Hydraulic Brace 4, (Pg. 6) is to keep discs in position and aid discs to change gear position for speed change, drive, or neutral.

Middle Mount 5 (pgs. 2 & 7) Support the Center Spring Hydraulic Brace 4 and mount for the electromagnets 6 and the bottom support 7. Electromagnets 6 generate very high magnetic field to turn the Drive Discs. Bottom Support 7, (Pg. 9) Provide support for bottom brace 1 to hold discs firmly in place. Drive Shaft 8, (pg. 10) distributes power, (torque) to drive conventional gear box then to the wheels for vehicle mobility. Shift cylinder 9 moves the gear 3 and Drive Shaft 8 when changing speed for drive, neutral and park. Position works also with the center spring Hydraulic Brace 4. This is done using computer control unit to activate both shift cylinder 9 and center spring Hydraulic Brace 4 simultaneously to each other when changing speed. Variable-Position Drive Shaft Section 10 allows for rearward and forward movement of Drive Shaft—as well as the rotary, (torque) action involved to turn the gears.

### DESCRIPTION—ADDITIONAL EMBODIMENT

Additional embodiments would entail application to such conveyance vehicles as watercraft, commercial, and non-commercial trucks, buses, and aircraft. According to features of present invention, adaptations are realizeable essentially relevant to the singular dynamics of the rotary, dual-disc, mechanism which can propel a vehicle

### CONCLUSION, RAMIFICATIONS, AND SCOPE

Accordingly, the reader will see that the above-presented novel idea for a fuelless passenger automobile is an item that is in great need. In this regard, it should be ascertained that environmental pollution will be decidedly diminished, if the present invention were to be generally put into use in the United States, as well as in other countries. Moreover, the concerns for relyance on other oil-producing countries will be assessed.

All in all, the prospect of driving from one end of the country to the other without ever having to “fill up” for gasoline should impress anyone who is serious about saving money, preserving health, doing something dramatically different for the country, or just, simply, doing the right thing.

1. I claim a means for propelling a vehicle, (passenger automobile) without benefit of any liquid or solid fuel comprising:
two longitudinally facing metallic discs of variable diameter, depending upon width of automobile, passing through the center of both layered disc is a vertical support which allows clockwise and counterclockwise spin of said discs, perpendicular peripheral width of surfaces of said discs will be magnetized for means of interaction with stationary electromagnets of same polarity of said peripheral surfaces, said interaction will cause said magnets to mutually repel each other causing said discs to spin in opposite directions, said discs will have, medially and laterally, interposed at opposite sides of said discs, lengths of two rods connecting with the facing sides of said discs, said rods will feature at their heads gears which will have means to fit into grooves for means of turning and supplying said turning power of said rods, (Drive Shafts—8) to connected rear and front wheels whereby vehicle will be caused to move in either a forward or rearward direction.
